(19) United States
(12) Patent Application Publication
(10) Pub. No.: US 2009/0248532 A1
(43) Pub. Date: Oct. 1, 2009

(54) COMMODITY SALES DATA PROCESSOR, RECEIPT SYSTEM, AND SCREEN DISPLAY METHOD FOR COMMODITY SALES DATA PROCESSOR

(75) Inventor: Nobuaki Sugiura, Shizuoka (JP)

Correspondence Address: TUROCY & WATSON, LLP, 127 Public Square, 57th Floor, Key Tower, CLEVELAND, OH, 44114, US

(73) Assignee: TOSHIBA TEC KABUSHIKI KAISHA, Tokyo (JP)

(21) Appl. No.: 12/411,421

(22) Filed: Mar. 26, 2009

(30) Foreign Application Priority Data
Apr. 1, 2008 (JP) 2008-095342

(51) Int. Cl. G06Q 30/00; G06Q 20/00

(52) U.S. Cl. 705/24; 705/26

(57) ABSTRACT

A commodity sales data processor which acquires commodity information corresponding to a commodity code entered through a commodity code input part from a commodity data file and calculates an amount of payment based on a unit price included in the commodity information. It generates receipt data as receipt information including the acquired commodity information and the calculated amount of payment and sends the receipt data through a communication part to a web server. It receives, from the web server, the URL of a web page in which the receipt data sent through the communication part is described in a form displayable with a mobile phone's browser function, and generates a code symbol as a description of the received URL and shows it on a customer display unit.

### CROSS-REFERENCE TO RELATED APPLICATION

This application is based upon and claims the benefit of priority from Japanese Patent Application No. 2008-095342, filed on Apr. 1, 2008, the entire contents of which are incorporated herein by reference.

### TECHNICAL FIELD

The present invention relates to a commodity sales data processor such as a POS terminal used in a store like a convenience store and a receipt system which provides receipt information to customers, and a screen display method for a commodity sales data processor.

### BACKGROUND

In recent years, an increasing number of customers bring tote bags as so-called “my bags” to convenience stores or similar stores and do not receive shopping bags which POS terminal operators give them after transactions. The use of “my bags” is said to contribute to solving environmental issues because it reduces consumption of shopping bags.

For further contribution to environmental conservation, it may be better to stop issuing receipts. This would prevent consumption of huge volumes of receipt paper, contributing greatly to solving environmental issues.

However, it is difficult to completely cease to issue receipts because after transactions some customers do not receive receipts but most customers request receipts.

Japanese Unexamined Patent Publication No. 2007-241527 describes that after a transaction with a customer, information relevant to that transaction is provided to the customer by a means other than a receipt. According to the technique described in Japanese Unexamined Patent Publication No. 2007-241527, a code symbol printed on a receipt is decoded using a mobile phone's decode function and information relevant to the transaction is displayed using its browser function. In this technique, since a receipt is once issued, receipt paper consumption is not reduced.

### SUMMARY

Accordingly, it is an object of the present invention to provide receipt information to customers without consuming receipt paper.

According to one aspect of the present invention, a commodity sales data processor includes: a commodity code input part for entering a commodity code which identifies a commodity; a customer display part which shows information for a customer; a communication part which enables data communication with a web server; and a control part, wherein the control part (i) performs commodity sales data processing by acquiring commodity information corresponding to a commodity code entered through the commodity code input part from a commodity data file storing a commodity code and commodity information including a unit price in a correlative manner, and calculating an amount of payment based on the unit price included in the commodity information, (ii) generates receipt data as receipt information including the acquired commodity information and the calculated amount of payment and sends the receipt data through the communication part to the web server, and (iii) receives, from the web server, a URL of a web page in which the receipt data sent through the communication part is described in a form displayable with a mobile phone's browser function, and generates a code symbol as a description of the received URL to show it on the customer display part.

According to another aspect of the present invention, a receipt system includes: a commodity sales data processor including: a control part; a commodity code input part for entering a commodity code which identifies a commodity; a customer display part which shows information for a customer; and a communication part which enables data communication with an external device, the control part: (i) performing commodity sales data processing by acquiring commodity information corresponding to a commodity code entered through the commodity code input part from a commodity data file storing a commodity code and commodity information including a unit price in a correlative manner, and calculating an amount of payment based on the unit price included in the commodity information; (ii) generating receipt data as receipt information including the acquired commodity information and the calculated amount of payment and sending the receipt data through the communication part; and (iii) receiving a URL through the communication part and generating a code symbol as a description of the received URL to show it on the customer display part; and a web server including: a server control part; and a server communication part for enabling data communication with the commodity sales data processor, the server control part receiving the receipt data and generating a web page as a description of the received receipt data in a form displayable with a mobile phone's browser function, and sending a URL for identifying the generated web page through the server communication part to the commodity sales data processor.

According to another aspect of the present invention, a screen display method for a commodity sales data processor includes: causing a control part to perform commodity sales data processing by acquiring commodity information corresponding to a commodity code entered through a commodity code input part from a commodity data file storing a commodity code and commodity information including a unit price in a correlative manner, and calculating an amount of payment based on a unit price included in the commodity information, the commodity code input part being used to enter a commodity code for identifying a commodity; causing the control part to generate receipt data as receipt information including the acquired commodity information and the calculated amount of payment, and to send the receipt data through a communication part to a web server, the communication part enabling data communication with the web server; and causing the control part to receive, from the web server, a URL of a web page in which the receipt data sent through the communication part is described in a form displayable with a mobile phone's browser function, and to generate a code symbol as a description of the received URL, to show it on a customer display part, the customer display part showing information for a customer.

According to a further aspect of the present invention, a screen display method for a commodity sales data processor includes: causing a commodity sales data processor's control part to perform commodity sales data processing by acquiring commodity information corresponding to a commodity code entered through a commodity code input part from a commodity data file storing a commodity code and commodity information including a unit price in a correlative manner, and calculating an amount of payment based on a unit price included in the commodity information, the commodity code input part being used to enter a commodity code for identifying a commodity; causing the commodity sales data processor's control part to generate receipt data as receipt information including the acquired commodity information and the calculated amount of payment, and to send the receipt data through a communication part to a web server, the communication part enabling data communication with the web server; causing the web server's server control part to receive the receipt data, generate a web page as a description of the received receipt data in a form displayable with a mobile phone's browser function, and to send a URL for identifying the generated web page through a server communication part to the commodity sales data processor, the server communication part enabling data communication with an external device; and causing the commodity sales data processor's control part to receive the URL, and to generate a code symbol as a description of the received URL, to show it on a customer display part, the customer display part showing information for a customer.

### DESCRIPTION OF THE DRAWINGS

A more complete appreciation of the present invention and many of the attendant advantages thereof will be readily obtained as the same becomes better understood by reference to the following detailed description when considered in connection with the accompanying drawings, wherein:

FIG. 1 is a system configuration diagram showing the system configuration of a receipt system;

FIG. 2 is a block diagram showing the hardware configuration of a web server;

FIG. 3 is a block diagram showing the hardware configuration of a mobile phone;

FIG. 4 is a perspective view of a POS terminal;

FIG. 5 is a perspective view of the POS terminal as seen from another direction;

FIG. 6 is a block diagram showing the hardware configuration of the POS terminal;

FIG. 7 is a flowchart showing the sequence of commodity sales data processing;

FIG. 8 is a schematic diagram showing one example of a screen on a customer display unit;

FIG. 9 is a schematic diagram showing another example of a screen on the customer display unit;

FIG. 10 is a front view of a mobile phone with a web page shown on a display part; and

FIG. 11 is a front view of the mobile phone with the web page shown on the display part.

### DETAILED DESCRIPTION

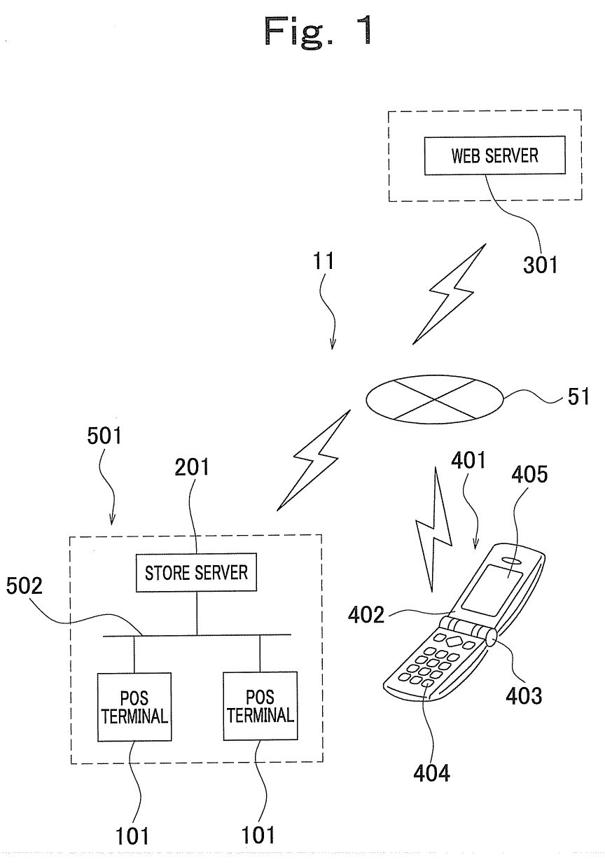

Next, the preferred embodiment of the present invention will be described referring to FIGS. 1 to 11.

FIG. 1 shows the configuration of a receipt system 11. The receipt system 11 in this embodiment is mainly comprised of a web server 301 connected with the Internet 51 and a POS system 501. An ordinary mobile phone 401 can be connected with the Internet 51.

The POS system 501 is installed in a convenience store. The POS system 501 is configured so that a plurality of POS terminals 101 as commodity sales data processors installed on cash register counters in a store are connected with a store server 201 in the store's backyard through a network line 502 (wired LAN) to enable data communications between them. The network line 502 is connected with the Internet 51.

The web server 301 is a general server computer. The web server 301 is installed, for example, in an Internet service provider's server room.

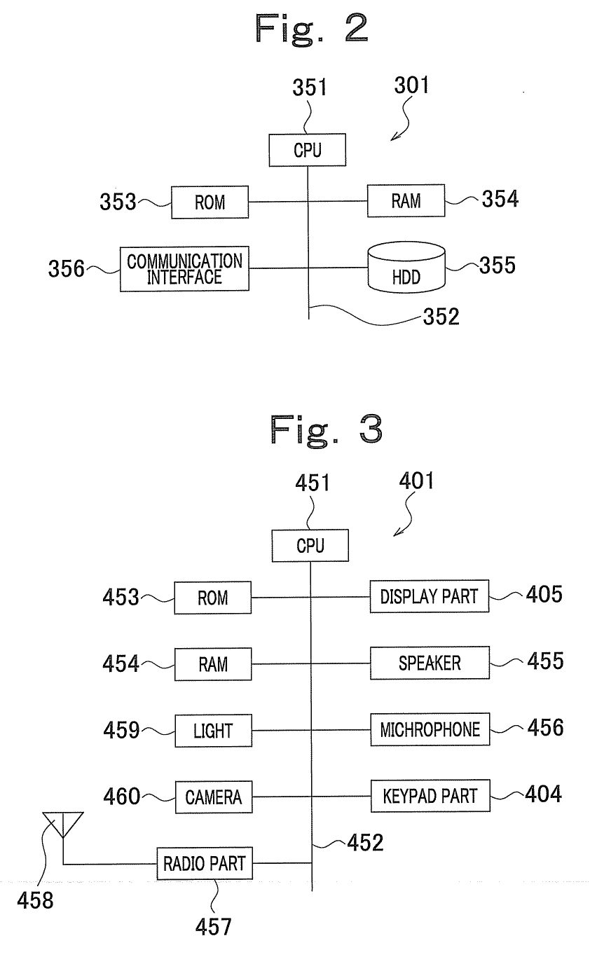

FIG. 2 is a block diagram showing the hardware configuration of the web server 301. The web server 301 includes a CPU 351 as a data processor which performs various computations and controls various components. The CPU 351 is connected through a bus line 352 with a ROM 353 for storing fixed data in a fixed manner and a RAM 354 used as a work area for storing variable data in a rewritable manner.

The CPU 351 is connected with a communication interface 356 as a server communication means through the bus line 352. The communication interface 356 enables connection with the Internet 51. Therefore, due to the communication interface 356, the web server 301 can communicate data with an external device connected with the Internet 51 and transmit data to a POS terminal 101 which is an external device, as a destination.

The CPU 351 is connected with an HDD 355 through the bus line 352. The HDD 355 stores web server software (not shown) which has a web data transmission function for use with the Internet 51. Also the HDD 355 stores web page data (not shown). The web page data stored in the HDD 355 can be acquired by a given communication terminal's browser function. A web page is shown on the communication terminal's display part through the browser function. One example of this kind of communication terminal is a mobile phone 401.

Next, the mobile phone 401 will be described, referring back to FIG. 1. The mobile phone 401 in this embodiment includes a housing 402 which can be freely opened and closed through a hinge 403 and the surface which is closed by the housing 402 includes a keypad part 404 which permits a user to enter information using the keys, and a display part 405 which shows information. The keypad part 404 includes alphanumeric keys for input of characters and numerals, a cross key which enables the user to select information shown on the display part 405 and move screens on the display part 405, and an OK key which accepts an operation or entry. The display part 405 is, for example, an LCD. A light 459 (see FIG. 3) which flickers to inform the user of arrival of a message or call is provided on the reverse side of the display part 405 of the housing 402. A camera 460 (see FIG. 3) for input of image data is provided on the reverse side of the keypad part 404 of the housing 402. The housing 402 incorporates an antenna 458 (FIG. 3) for transmitting and receiving radio waves, a radio part 457 (FIG. 3) for controlling transmissions and receptions in wireless communications, a speaker 455 (FIG. 3) for output of audio signals, and a microphone 456 (FIG. 3) for input of audio signals from the user.

FIG. 3 is a block diagram showing the hardware configuration of the mobile phone 401. The mobile phone 401 includes the CPU 451 as a data processor which performs various computations and controls various components. The CPU 451 is connected through a bus line 452 with a ROM 453 which stores fixed data such as given programs and communication control data in a fixed manner and a RAM 454 used as a work area which stores variable data in a rewritable manner. The RAM 454 is an EEPROM which partly includes a nonvolatile memory. The CPU 451 is connected with a keypad part 404, a display part 405, a light 459, a camera 460, a radio part 457, a speaker 455, and a microphone 456 through a bus line 452 and these components are controlled by the CPU 451 which operates according to a program.

The mobile phone 401 in this embodiment has a decode function to read a code symbol entered through the camera 460 and decode it into information described by it. One example of a code symbol which can be read and decoded by this decode function is a 2-dimensional code symbol.

The mobile phone 401 in this embodiment has a browser function. The browser function acquires data relevant to a URL entered and specified on the mobile phone 401 by communication with a server computer including the web server 301 using HTTP or the like and analyzes the acquired data according to its type (HTML, CHTML, image, text, etc) and arranges and resizes the text and image according to the result of analysis to show them on the display part 405.

The decode function and browser function are performed by the CPU 451 executing a program stored in the ROM 453 or the like. Since these functions are ordinary functions which commercially available mobile phones have, detailed descriptions of them are omitted here.

Next, the POS terminal 101 which constitutes the POS system 501 will be described. Since the store server 201 as an upstream device for the POS terminal 101 has the same configuration as a general server computer, its description is omitted here.

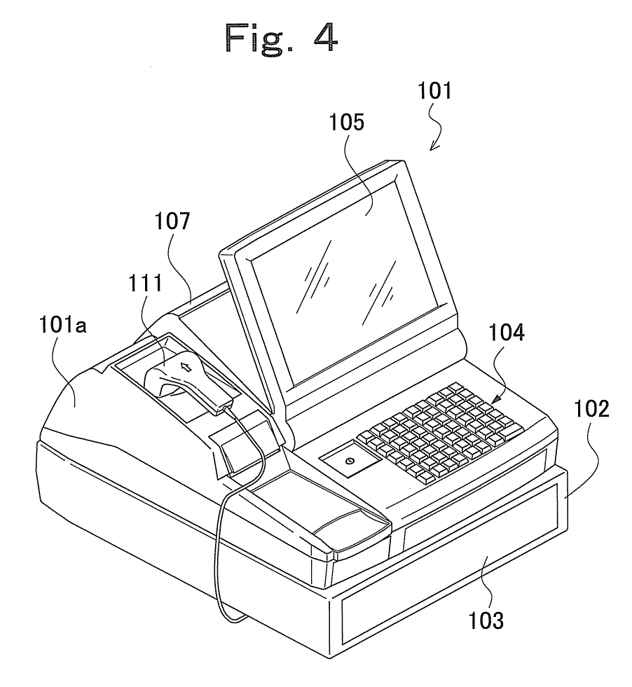

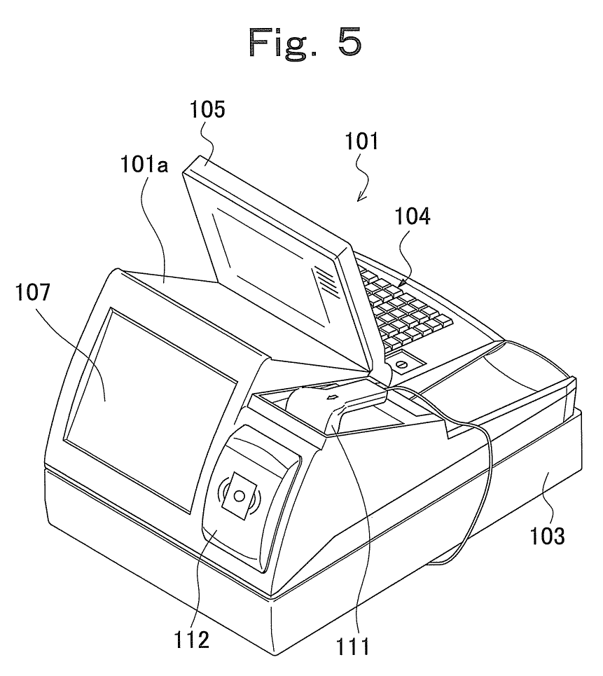

FIG. 4 is a perspective view of the POS terminal 101. FIG. 5 is a perspective view of the POS terminal 101 as seen from another direction. The POS terminal 101 rests on a drawer 102 mounted on a cash register counter in a store and can control opening and closing of a drawer case 103 of the drawer.

As shown in FIG. 4, an operator display unit 105 is provided as an information display unit for the operator on the upper surface of the housing 101a of the POS terminal 101. The operator display unit 105 is, for example, an LCD. A keyboard 104 for input of information into the POS terminal 101 is located in front of the operator display unit 105. The keyboard 104 includes numerical keys which each have a number printed on the top, a temporary finalization key with letters “subtotal” printed on the top, and a finalization key with letters “cash/amount tendered” printed on the top. The finalization key is a key which is pressed to declare the end of commodity sales data processing (explained later) which is performed by the POS terminal 101.

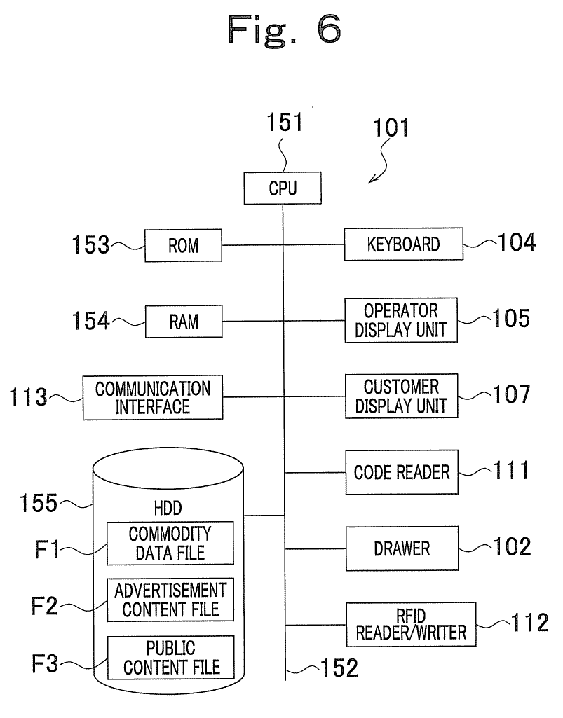

The POS terminal 101 is connected with a code reader 111 as a commodity code input part which optically reads the commodity code attached to each commodity as a code symbol (JAN, etc). The code reader 111 is temporarily located on the left of the operator display unit 105. The code reader 111 emits a given pattern of visible semiconductor laser light and its photo-sensor receives reflected light from the code symbol. The code reader 111 decodes the received light signal of the code symbol based on an output signal from the photo-sensor and acquires the commodity code described by the code symbol and sends it to the CPU 151 of the POS terminal 101 (see FIG. 6).

As shown in FIG. 5, a customer display unit 107 is provided as an information display unit for a customer on the customer side of the housing 101a of the POS terminal 101. The customer display unit 107 is, for example, an LCD. An RFID reader/writer 112 is provided integrally with the housing 101a on the right of the customer display unit 107 as seen from the customer side. The RFID reader/writer 112 establishes communication with a passive RFID tag (not shown) placed opposite the RFID reader/writer 112 and reads data from, or writes data into, the IC chip (not shown) of the RFID tag. The RFID tag is, for example, a plastic membership card or electronic money card. In some cases, the RFID tag is built in the mobile phone 401. The RFID reader/writer 112 acquires the customer code and electronic money data stored in the IC chip and sends them to the CPU 151 of the POS terminal 101 (see FIG. 6).

FIG. 6 is a block diagram showing the hardware configuration of the POS terminal 101. The POS terminal 101 includes a CPU 151 as a data processor which performs various computations and controls various components. The CPU 151 is connected through a bus line 152 with a ROM 153 for storing fixed data in a fixed manner and a RAM 154 used as a work area for storing variable data in a rewritable manner.

The CPU 151 is connected with a drawer 102, a keyboard 104, an operator display unit 105, a customer display unit 107, a code reader 111, and an RFID reader/writer 112 through various input/output circuits (not shown) and these components are controlled by the CPU 151.

The CPU 151 is connected with a communication interface 113 through a bus line 152. The communication interface 113 is connected with the store server 201 and Internet 51 through the network line 502. Therefore, the POS terminal 101 can communicate data through the communication interface 113 with the web server 301 connected with the Internet 51 and can send data to the web server 301 as a destination.

The CPU 151 is connected with the HDD 155 through the bus line 152. The HDD 155 stores an operating system, computer programs and various files and when the POS terminal 101 is started, all or some of them are copied into the RAM 154 where the copies are used. The CPU 151 executes computer programs as copied into the RAM 154.

A real-time clock (not shown) as a clock chip is provided on the mother board (not shown) of the POS terminal 101. The operating system acquires date and time data from the real-time clock at its start and then keeps time automatically.

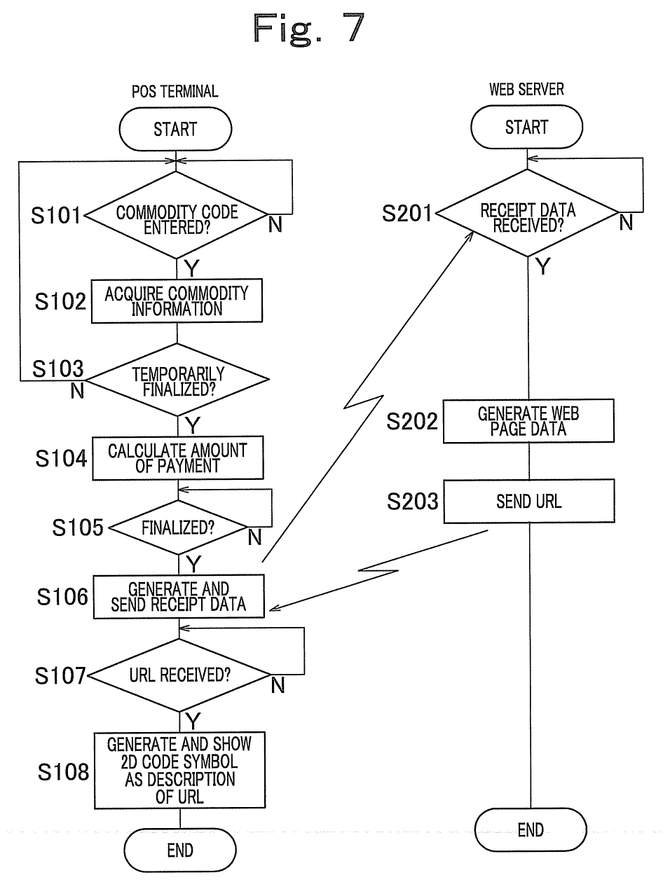

One example of processing which the CPU 151 performs according to a computer program is commodity sale data processing. Generally speaking, commodity sales data processing is a process in which the amount of payment is calculated based on the commodity code sent from the code reader 111 (see FIG. 7).

One example of a file stored in the HDD 155 is a commodity data file F1. The commodity data file F1 is a file which stores a commodity's unit price, commodity name and commodity information such as discount information in correlation with the commodity code as an identifier of the commodity. During commodity sales data processing, the CPU 151 accesses the data file.

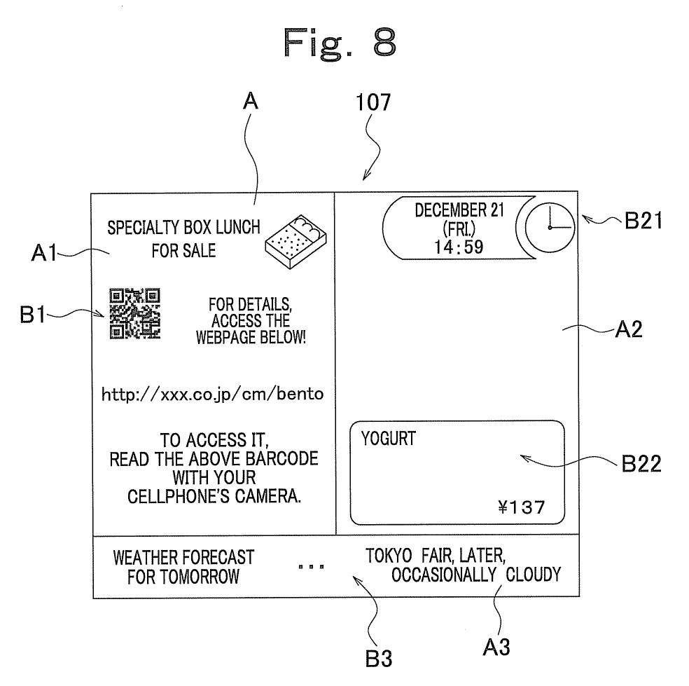

Another example of a file stored in the HDD 155 is an advertisement content file F2. The advertisement content file F2 is a file which stores data as advertisement information display B1 (see FIG. 8) which appears on the customer display unit 107 during commodity sales data processing. The advertisement information display B1 which appears on the customer display unit 107 gives the customer advertisement information on a commodity for sale or expected to be sold at the store where the POS system 501 is installed. The advertisement information display B1 shows the commodity's image, commodity name, unit price and so on. Therefore, the advertisement information display B1 includes text data and image data and also layout information.

A further example of a file stored in the HDD 155 is a public content file F3. As in case of the advertisement information display B1, the public content file F3 is a file which stores the data of public information display B3 (see FIG. 8) which appears on the customer display unit 107 during commodity sales data processing. The public information display B3 which appears on the customer display unit 107 informs the customer of public information related to the local area where the store having the POS system 501 is located (for example, weather forecast). The public information display B3 mainly includes text data.

The commodity data file F1, advertisement content file F2 and public content file F3 are distributed from the store server 201 connected with the POS terminal 101 in a data-communicable manner and stored in the HDD 155 of the POS terminal 101. The public content file F3 may be distributed directly from the Internet 51 to the POS terminal 101.

In the POS terminal 101 according to this embodiment, the CPU 151 generates receipt data (explained later) for each transaction as it processes commodity sales data. The receipt data includes a unique receipt code.

The receipt code is a combination of a “POS terminal code” for identifying each POS terminal 101 and a “transaction code” for identifying each transaction. For example, if the POS terminal code is 02 and the transaction code is 1234, the receipt code, a combination of them, is 021234. The POS terminal code and the transaction code are stored in the RAM 154 of the POS terminal 101. While the POS terminal code is invariable, the transaction code is incremented by the CPU 151 upon each transaction. Therefore, the receipt code which the same POS terminal 101 generates next is 021235.

FIG. 7 is a flowchart showing the sequence of commodity sales data processing. The CPU 151 of the POS terminal 101 waits for input of a commodity code from the code reader 111 which reads a code symbol (Act S101). If it is decided that the commodity code has been entered (Yes at Act S101), the CPU 151 temporarily stores the entered commodity code in the RAM 154 and acquires commodity information corresponding to that commodity code from the commodity data file F1 (Act S102). The acquired commodity information is temporarily stored in the RAM 154. At this moment, the CPU 151 of the POS terminal 101 shows commodity information display B22 (see FIG. 8) based on the acquired commodity information on the customer display unit 107.

FIG. 8 schematically shows one example of a screen on the customer display unit 107. A transaction screen A which appears during a transaction is shown on the whole screen area of the customer display unit 107. The transaction screen A includes an advertisement area A1 occupying a left part of the screen and a user area A2 occupying a right part of the screen and a horizontally long public area A3 occupying the bottom of the screen. The advertisement area A1 contains advertisement information display B1 based on the data stored in the advertisement content file F2. The public area A3 contains public information display B3 based on the data stored in the public content file F3.

The advertisement information display B1 as exemplified in FIG. 8 is an advertisement of a specialty box lunch which includes a URL text for a web page giving detailed information of the specialty box lunch and a 2-dimensional code symbol as a description of the URL. At this time, the decode function of the mobile phone 401 can be used to make the camera 460 read the 2-dimensional code symbol included in the advertisement information display B1 and decode it into a URL. Also, the browser function of the mobile phone 401 can be used to specify the URL obtained by decoding and acquire the relevant web page data and show the web page of the advertisement of the specialty box lunch on the display part 405. It is also possible to arrange that advertisement information display B1 for a commodity other than the specialty box lunch appears in the advertisement area A1 over time.

In the example of FIG. 8, the public information display B3 shows “weather forecast for tomorrow” in “Tokyo” in the form of text. The public area A3 may scroll from right to left so that other public information displays B3 showing weather forecasts for tomorrow in regions other than Tokyo appear one after another.

In the example of FIG. 8, time display B21 appears at the top of the user area A2. The time display B21 shows date and time according to the clock of the operating system. The time shown in the time display B21 is the present time.

As described above, the commodity information display B22 appears at the bottom of the user area A2. The commodity information display B22 shows the commodity information in the form of text as acquired from the commodity data file F1 corresponding to the commodity code read by the code reader 111.

Referring back to FIG. 7, Acts S101 and S102 are repeatedly carried out until the temporary finalization key marked “subtotal” on the keyboard 104 is pressed (Yes at Act S103). If the CPU 151 confirms that the temporary finalization key is pressed (Yes at Act S103), it calculates an amount of payment based on the unit price temporarily stored in the RAM 154 and temporarily stores it in the RAM 154 (Act S104). Basically the amount of payment is the total of unit prices. However, if the commodity information acquired from the commodity data file F1 at Act S102 includes discount information, the discount information is reflected in the amount of payment.

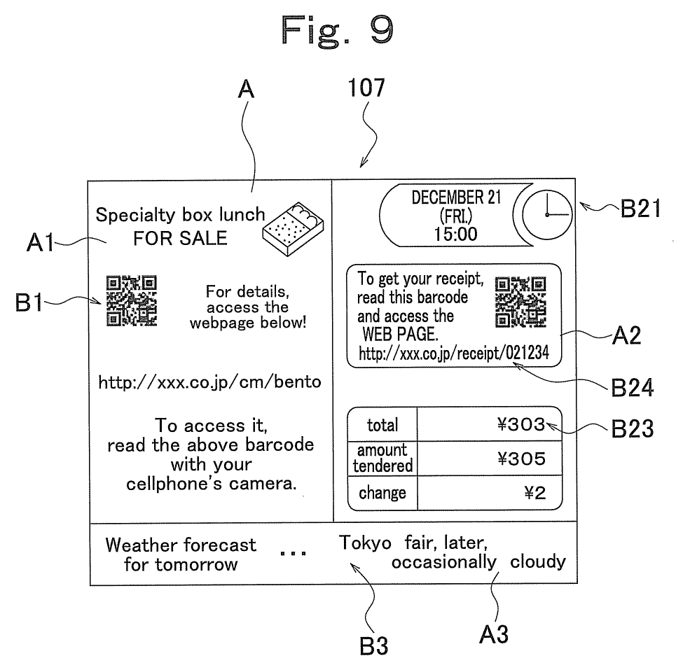

The CPU 151 of the POS terminal 101 shows the calculated amount of payment on the customer display unit 107 as amount information display B23 (see FIG. 9). The customer looks at the amount of payment shown on the customer display unit 107 and pays the amount by cash or electronic money. If the customer makes the payment by cash, the operator enters the amount tendered by the customer into the POS terminal 101 using the numeric keys of the keyboard 104. The CPU 151 temporarily stores the entered amount in the RAM 154 as the amount tendered and subtracts the amount of payment from the amount tendered to calculate the amount of change and temporarily stores the calculated amount of change in the RAM 154. If the customer makes the payment by electronic money, the operator urges the customer to make the electronic money card (RFID tag) or the mobile phone with a built-in RFID tag face the RFID reader/writer 112. As a consequence, the RFID reader/writer 112 can communicate with the RFID tag and debits the amount of payment against the electronic money account stored in the IC chip. The CPU 151 of the POS terminal 101 temporarily stores the amount of electronic money checked off in the RAM 154 as the amount tendered. The CPU 151 of the POS terminal 101 lets the customer display unit 107 show the amount tendered and the amount of change as money information display B23 (see FIG. 9).

The CPU 151 of the POS terminal 101 waits for the operator to press the finalization key marked “cash/amount tendered” on the keyboard 104 (Act S105). If the finalization key is pressed (Yes at Act S105), the CPU 151 of the POS terminal 101 generates receipt data (Act S106). The receipt data generated by the CPU 151 includes the commodity information, amount of payment, amount tendered, amount of change which are temporarily stored in the RAM 154 and also the present clock time as transaction time (date and time) which identifies each transaction. The receipt data also includes the unique receipt code described referring to FIG. 6. The CPU 151 transmits the generated receipt data through the Internet 51 to the web server 301 as the destination (Act S106).

As the CPU 351 of the web server 301 receives the receipt data from the POS terminal 101 through the communication interface 356 (Yes at Act S201), the CPU 351 of the web server 301 generates data of a web page in which receipt information based on the received receipt data is described (Act S202). The generated web page data includes text data such as the commodity information, amount of payment, amount tendered, amount of change, transaction time and receipt code as well as HTML layout information. The generated web page data is stored in the HDD 355 of the web server 301. The web page data is stored, for example, in a folder named “receipt” under the name of 021234 (receipt code).

The CPU 351 of the web server 301 sends a URL for identifying the generated web page data, to the POS terminal 101 (Act S203). The POS terminal 101 as the destination is the POS terminal 101 which has sent the receipt data.

The URL is alphanumeric text, for example, http://xxx.co.jp/receipt/021234. “xxx.co.jp” in the URL is a host name representing the web server 301 as the host. “/receipt/021234” in the URL identifies a web page stored in the web server 301.

As the CPU 151 of the POS terminal 101 receives the URL from the web server 301 through the communication interface 113 (Yes at Act S107), the CPU 151 of the POS terminal 101 generates a 2-dimensional code symbol which describes the URL (Act S108). Therefore, a computer program which turns alphanumeric text like a URL into a 2-dimensional code symbol is stored in the HDD 355 of the POS terminal 101. The CPU 151 of the POS terminal 101 generates link information display B24 (see FIG. 9) including the generated 2-dimensional code symbol and shows the link information display B24 in the user area A2 of the transaction screen A on the customer display unit 107 (Act S108).

FIG. 9 schematically shows another example of a screen on the customer display unit 107. In the transaction screen A, the advertisement information display B1 in the advertisement area A1, the time display B21 in the user area A2 and the public information display B3 in the public area A3 are the same as those described above referring to FIG. 8 and descriptions of them are omitted here.

As shown in FIG. 9, the amount information display B23 appears in place of the commodity information display B22 (FIG. 8) in the lower part of the user area A2. In the amount information display B23, the amount of payment calculated by temporary finalization and stored in the RAM 154 is shown on the right of the letters TOTAL. Likewise, the amount tendered as stored in the RAM 154 is shown on the right of the letters AMOUNT TENDERED and the amount of change is shown on the right of the letters CHANGE.

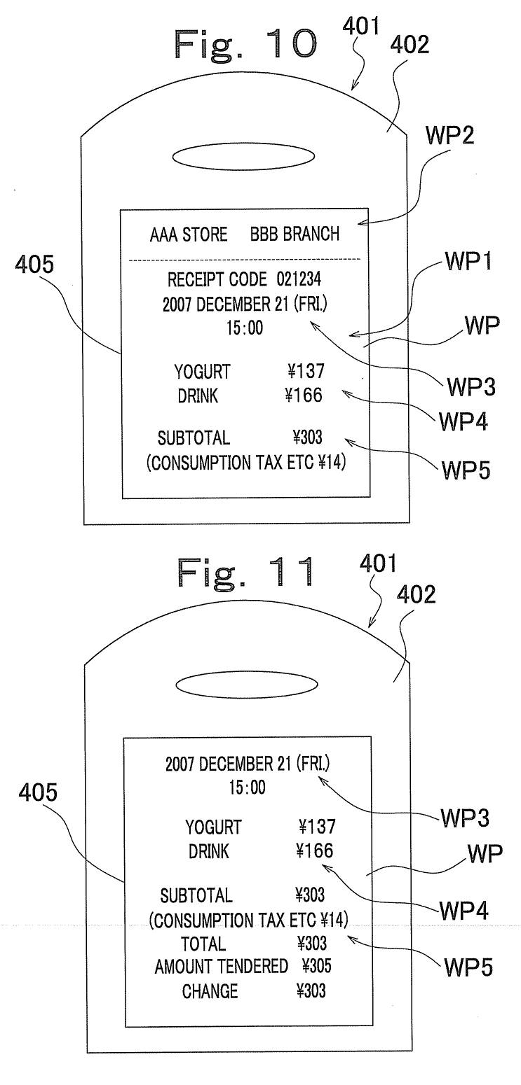

As shown in FIG. 9, link information display B24 appears above the amount information display B23 in the user area A2. The link information display B24 includes a 2-dimensional code symbol which describes the URL sent from the web server 301 as mentioned earlier. Here, the decode function of the mobile phone 401 may be used to make the camera 460 read the 2-dimensional code symbol included in the link information display B24 and decode it into a URL. Also the browser function of the mobile phone 401 may be used to specify the URL obtained by decoding and acquire the relevant web page data from the web server 301 and show a web page WP (see FIGS. 10 and 11) as a description of receipt information on the display part 405. The link information display B24 also shows text which represents the URL sent from the web server 301. Therefore, the URL may also be directly entered using the keypad part 404 of the mobile phone 401.

FIGS. 10 and 11 are front views of the mobile phone 401 where a web page WP is shown on the display part 405. The web page WP shown on the display part 405 describes receipt information based on the receipt data identified by the receipt code 021234. For this reason, receipt code WP1 expressed by one row of characters (text) “RECEIPT CODE 021234” is shown under a store logo WP2 in the web page WP. The store logo WP2, which is also expressed by text, is added in the process of generating data for the web page WP.

What is shown in FIG. 10 is only part of all the information given by the web page WP and does not include the latter half of the web page because the screen area of the display part 405 is small. Specifically, in addition to the store logo WP2 and receipt code WP1, it shows the date and time of transaction, WP3, commodity information WP4, and part of amount information WP5. By pressing the “down” part of the cross key of the keypad part 404 of the mobile phone 401, the web page WP scrolls up in the screen on the display part 405. Consequently, all of the amount information WP5 is shown on the display part 405 as shown in FIG. 11. At this time, the store logo WP2 and receipt code WP1 disappear from the screen on the display part 405. Therefore the customer can access the web page WP as a description of the receipt information so that after a transaction the customer can obtain the receipt information about the transaction.

The web page WP data can be stored in the RAM 454 using an ordinary function of the mobile phone 401. Furthermore, the data can be loaded at any time to show the web page WP on the display part 405. Therefore, it may be an idea to arrange that after a given expiration date, it becomes impossible to obtain the data from the web server 301 using the browser function of the mobile phone 401.

As described above, according to this embodiment, receipt information can be provided to the customer without consumption of receipt paper. This will prevent consumption of huge volumes of receipt paper and contribute largely to solving environmental issues.

Obviously, numerous modifications and variations of the present invention are possible in light of the above teachings. It is therefore to be understood that within the scope of the appended claims, the invention may be practiced otherwise than as specifically described herein.

What is claimed is:

1. A commodity sales data processor comprising:
a commodity code input part for entering a commodity code which identifies a commodity;
a customer display part which shows information for a customer;
a communication part which enables data communication with a web server; and
a control part which:
(i) performs commodity sales data processing by acquiring commodity information corresponding to a commodity code entered through the commodity code input part from a commodity data file storing a commodity code and commodity information including a unit price in a correlative manner, and calculating an amount of payment based on the unit price included in the commodity information;
(ii) generates receipt data as receipt information including the acquired commodity information and the calculated amount of payment and sends the receipt data through the communication part to the web server; and
(iii) receives, from the web server, a URL of a web page in which the receipt data sent through the communication part is described in a form displayable with a mobile phone's browser function, and generates a code symbol as a description of the received URL to show it on the customer display part.

2. The commodity sales data processor according to claim 1, further comprising:
a finalization key to declare end of the commodity sales data processing,
wherein the control part generates and sends the receipt data as the finalization key is pressed.

3. The commodity sales data processor according to claim 1,
wherein the code symbol as a description of the URL is a 2-dimensional code symbol.

4. The commodity sales data processor according to claim 2,
wherein the code symbol as a description of the URL is a 2-dimensional code symbol.

5. A receipt system comprising:
a commodity sales data processor comprising: a control part; a commodity code input part for entering a commodity code which identifies a commodity; a customer display part which shows information for a customer; and a communication part which enables data communication with an external device, the control part: (i) performing commodity sales data processing by acquiring commodity information corresponding to a commodity code entered through the commodity code input part from a commodity data file storing a commodity code and commodity information including a unit price in a correlative manner, and calculating an amount of payment based on the unit price included in the commodity information; (ii) generating receipt data as receipt information including the acquired commodity information and the calculated amount of payment and sending the receipt data through the communication part; and (iii) receiving a URL through the communication part and generating a code symbol as a description of the received URL to show it on the customer display part; and
a web server comprising: a server control part; and a server communication part for enabling data communication with the commodity sales data processor, the server control part receiving the receipt data and generating a web page as a description of the received receipt data in a form displayable with a mobile phone's browser function, and sending a URL for identifying the generated web page through the server communication part to the commodity sales data processor.

6. The receipt system according to claim 5,
wherein the commodity sales data processor comprises a finalization key to declare end of the commodity sales data processing; and
wherein the control part generates and sends the receipt data as the finalization key is pressed.

7. The receipt system according to claim 5,
wherein the code symbol as a description of the URL is a 2-dimensional code symbol.

8. The receipt system according to claim 6,
wherein the code symbol as a description of the URL is a 2-dimensional code symbol.

9. A screen display method for a commodity sales data processor comprising:
causing a control part to perform commodity sales data processing by acquiring commodity information corresponding to a commodity code entered through a commodity code input part from a commodity data file storing a commodity code and commodity information including a unit price in a correlative manner, and calculating an amount of payment based on a unit price included in the commodity information, the commodity code input part being used to enter a commodity code for identifying a commodity;
causing the control part to generate receipt data as receipt information including the acquired commodity information and the calculated amount of payment, and to send the receipt data through a communication part to a web server, the communication part enabling data communication with the web server; and
causing the control part to receive, from the web server, a URL of a web page in which the receipt data sent through the communication part is described in a form displayable with a mobile phone's browser function, and to generate a code symbol as a description of the received URL, to show it on a customer display part, the customer display part showing information for a customer.

10. A screen display method for a commodity sales data processor comprising:
causing a commodity sales data processor's control part to perform commodity sales data processing by acquiring commodity information corresponding to a commodity code entered through a commodity code input part from a commodity data file storing a commodity code and commodity information including a unit price in a correlative manner, and calculating an amount of payment based on a unit price included in the commodity information, the commodity code input part being used to enter a commodity code for identifying a commodity;
causing the commodity sales data processor's control part to generate receipt data as receipt information including the acquired commodity information and the calculated amount of payment, and to send the receipt data through a communication part to a web server, the communication part enabling data communication with the web server;
causing the web server's server control part to receive the receipt data, to generate a web page as a description of the received receipt data in a form displayable with a mobile phone's browser function, and to send a URL for identifying the generated web page through a server communication part to the commodity sales data processor, the server communication part enabling data communication with an external device; and
causing the commodity sales data processor's control part to receive the URL, and to generate a code symbol as a description of the received URL, to show it on a customer display part, the customer display part showing information for a customer.
